(19) United States
(12) Patent Application Publication
(10) Pub. No.: US 2018/0035293 A1
(43) Pub. Date: Feb. 1, 2018

(54) AUTHENTICATING A DEVICE UTILIZING A SECURE DISPLAY

(71) Applicant: QUALCOMM Incorporated, San Diego, CA (US)

(72) Inventors: Or Elnekaveh, Kfar Vitkin (IL); Amit Blay, Haifa (IL); Shlomi Agmon, Modiin (IL)

(21) Appl. No.: 15/341,780

(22) Filed: Nov. 2, 2016

Related U.S. Application Data
(60) Provisional application No. 62/368,659, filed on Jul. 29, 2016.

(51) Int. Cl. H04W 12/06; H04W 12/04; H04L 9/32; H04L 29/06; H04L 9/14; H04L 9/30

(52) U.S. Cl. CPC H04W 12/06; H04L 9/14; H04L 9/30; H04L 9/3247; H04L 63/0861; H04W 12/04; H04L 63/06; H04L 67/42; H04L 2209/80

(57) ABSTRACT

Aspects may relate to a device that comprises a storage, an interface, and a processor. The processor coupled to the interface and operable in a secure mode may be configured to: command the transmission of a nonce through the interface to a server over a channel and receive through the interface a response from the server including an identifier and the nonce over the channel, in which, the response is signed with a private key of the server. Further, the processor operable in the secure mode may be configured to: verify the signature with a public key of the server; verify the nonce; store the identifier in the storage; and display the identifier on a secure display to initiate authentication with the server.

### CROSS REFERENCE TO RELATED APPLICATIONS

The present application claims priority to U.S. Provisional Patent Application No. 62/368,659, filed Jul. 29, 2016, entitled “AUTHENTICATING A DEVICE UTILIZING A SECURE DISPLAY,” the content of which is hereby incorporated by reference in its entirety for all purposes.

### BACKGROUND

### Field

The present invention relates to authenticating a device utilizing a secure display.

### Relevant Background

When two Trusted Computing Bases (TCBs), such as, a device and a server, communicate with each other over an untrusted channel, sent messages between these two parties may become susceptible to passive and active man-in-the-middle attacks (MiTMAs). Passive attacks may simply observe the traffic, while active attacks may modify the data.

Overcoming MiTMAs typically requires strong mutual authentication, which means the ability of each side to prove cryptographically its identity to the other side. One such proof may be a cryptographic signature of a challenge (e.g., a nonce) provided by the other party.

In many situations however, only one side may possess the necessary key material to prove its identity. For example, a mobile device communicating with a cloud server. Both sides may have a TCB, the server may have a TCB (for example, a hardware security module (HSM)) and the device may have a TCB (for example, a Trusted Execution Environment (TEE)). Often, the cloud server may have in its TCB a key pair, a private key and a public key. The mobile device's TCB may have the public key embedded in its TEE code. In this scenario, a cloud server may prove its identity to a mobile device by signing with its private key a random challenge created by the mobile device and it's TEE.

However, since there is only one cloud server, and many mobile devices, the reverse authentication, i.e., having the device prove its identity to the server is more difficult and requires the server to have the public key of each device. A Public Key Infrastructure (PKI) may be associated with this case.

As a result, commonly utilized solutions today lack the ability for a mobile device to identify itself to a server in a way that is immune to MiTM attacks.

### SUMMARY

Aspects may relate to a device that comprises a storage, an interface, and a processor. The processor coupled to the interface and operable in a secure mode may be configured to: command the transmission of a nonce through the interface to a server over a channel and receive through the interface a response from the server including an identifier and the nonce over the channel, in which, the response is signed with a private key of the server. Further, the processor operable in the secure mode may be configured to: verify the signature with a public key of the server; verify the nonce; store the identifier in the secure storage; and display the identifier, or a derivative of the identifier (e.g., such as an item generated from the identifier, such as, a QR code or time based code, as will be described in more detail hereafter), on a secure display to initiate authentication with the server.

### BRIEF DESCRIPTION OF THE DRAWINGS

FIG. 1 is a diagram of a system in which embodiments may be practiced.

FIG. 2 is a flow diagram of a process to provide one-time initial provisioning and to initiate authentication.

FIG. 3 is a diagram showing examples of authentication techniques.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

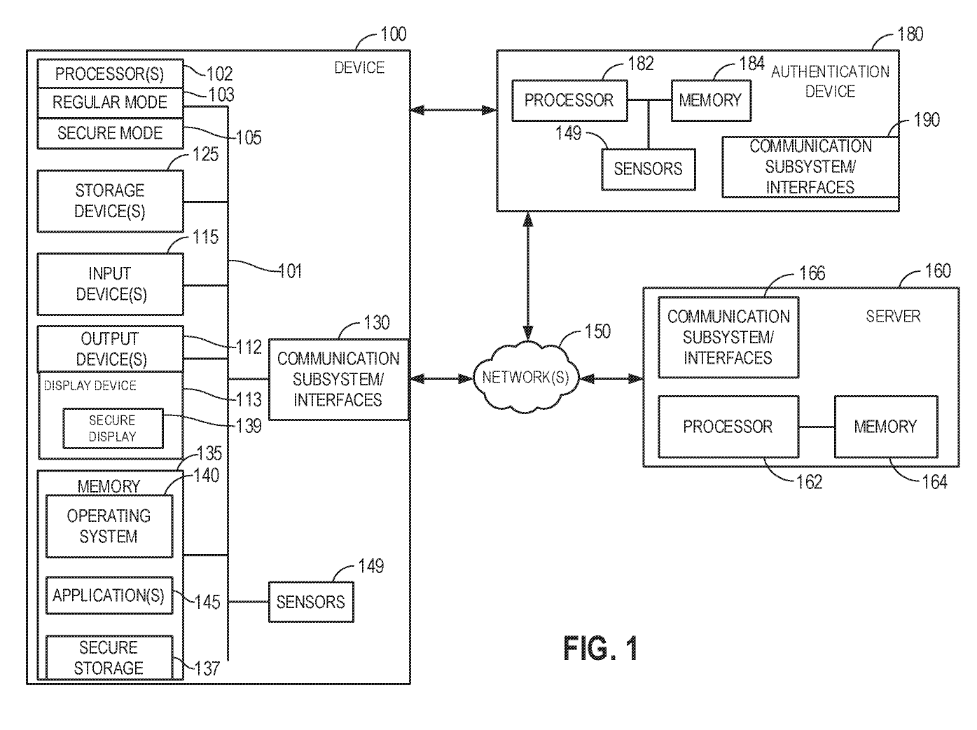

With reference to FIG. 1, an example device 100 may be in communication with one or more other devices 160 (e.g., servers), respectively, via networks 150. For example, device 160 may be a server 160 that operates as a service provider (e.g., commerce, product providers, service providers, financial, medical, government, corporate, social networking, etc.) that provides products, services, etc., based on data exchanges with computing device 100 through the networks 150. Although, a server is described as one example, it should be appreciated that the device may any type of device or may comprise multiple devices.

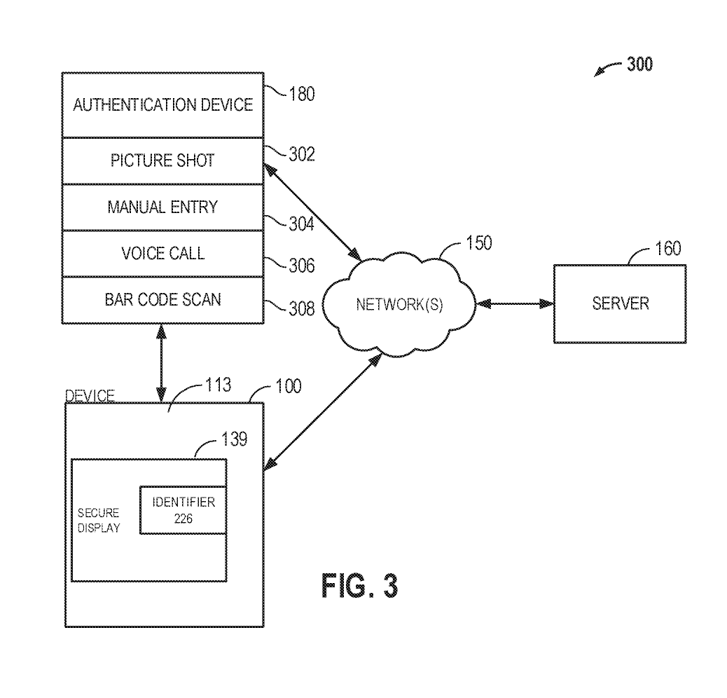

As an example, device 100 may comprise hardware elements that can be electrically coupled via a bus 101 (or may otherwise be in communication, as appropriate). The hardware elements may include one or more processors 102, including without limitation one or more general-purpose processors and/or one or more special-purpose processors (such as secure processors, cryptoprocessors, digital signal processing chips, graphics acceleration processors, and/or the like); one or more input devices 115 (e.g., keyboard, keypad, touchscreen, mouse, etc.)—in one embodiment, the input may be a secure input, as will be described; and one or more output devices 112—such as a display device (e.g., screen) 113, speaker, etc. In one embodiment, display device 113 may provide a secure display 139 that will be described in more detail hereafter. However, it should be appreciated, that secure display 139 may be displayed by different displays of device 100 at different locations. Also, as will be described in more detail, an identifier 226 may be displayed with the secure display 139 (e.g., description with reference to FIG. 3). Additionally, computing device 100 may include a wide variety of sensors 149. Sensors may include: a clock, an ambient light sensor (ALS), a biometric sensor (e.g., blood pressure monitor, a fingerprint sensor, etc.), an accelerometer, a gyroscope, a magnetometer, an orientation sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone, a camera, or any type of sensor.

Also, as one optional example, processor 102 operating in secure mode 105 may command the display device 113 to display a security indicator to the user. The security indicator may be any visual aid that allows the user to determine visually that the display is currently operated by secure mode 105, and not by an imposter. Such a secure indicator might be a discrete element such as a LED or an image shown on secure display 139 which is only known to secure mode 105 and the user. For example, if the displayed security indicator image is not the security indicator that the user is familiar with, then the user can notice by the incorrect security indicator that the identifier is not to be trusted and may be compromised such that the user is notified not to proceed.

In one embodiment, processor 102 may operate in a regular mode 103 and/or a secure mode 105. In one embodiment, processor 102 may itself be a secure processor and/or operate in the secure mode 105 to create a trusted execution environment (TEE) to allow for security procedures, such as, running trusted applications, utilizing keys, verifying signatures, and displaying identifiers on secure display 139 for authentications purposes with server 160, as will be described in more detail hereafter.

Device 100 may further include (and/or be in communication with) one or more non-transitory storage devices 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communications subsystems and/or interfaces 130 may permit data to be exchanged with other devices (e.g., servers 160, etc.) through appropriate networks 150 (wireless and/or wired). As should be appreciated communication through networks 150 may be through a channel.

In some embodiments, device 100 may further comprise a working memory 135, which may include volatile or non-volatile memory (e.g., RAM and/or ROM). Device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a device 100 to perform one or more operations in accordance with the described methods, according to embodiments described herein.

A set of these instructions and/or code may be stored on a non-transitory computer-readable storage medium, such as the storage device(s) 125 described above. In some cases, the storage medium might be incorporated within a computer system, such as device 100. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by device 100 and/or might take the form of source and/or installable code, which, upon compilation and/or installation on device 100 (e.g., using any of a variety of generally available compilers, installation programs, compression/decompression utilities, etc.), then takes the form of executable code.

Also, device 100 may include a storage 137. In one embodiment, the storage may be a secure storage 137, to allow for the storage of identifiers in a trusted execution environment (TEE), as will be described hereafter, and to store and enable trusted applications to operate in a trusted execution environment to implement the processes to be hereafter described (hereafter the term secure storage 137 will be utilized, although it should be appreciated that any type of storage may be utilized). Secure storage 137 may be any type of suitable non-volatile memory or volatile memory often utilized for security purposes in a trusted execution environment. For example, secure storage 137 may be a separate secure storage area in a TEE utilized only by trusted applications and is separate from other non-secure storage areas. Also, data stored in secure storage 137 may be encrypted and/or integrity protected.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein.

As previously described, device 100 may be any type of device, computer, smartphone, tablet, cellular telephone, watch, wearable device, Internet of Things (IoT) device, or any type of computing device that can communicate with other devices (e.g., a server 160) via a wired and/or wireless networks 150. Further, as has been previously described, device 100 may be in communication via interface 130 through a channel through networks 150 to service provider 160. It should be appreciated that service provider 160 may be a device having at least a processor(s) 162, a memory 164, an interface/communication subsystem 166, as well as other hardware and software components, to implement operations. For example, device 160 may be a server 160 that operates as a service provider (e.g., commerce, product providers, service providers, financial, medical, government, corporate, social networking, etc.) that provides products, services, etc., based on data exchanges with computing device 100 through the network 150. It should be appreciated that computing device 100 and server 160 may be in communication through networks 150 in a wireless, wired, or combination of wireless/wired fashion. Although, a server is described as one example, it should be appreciated that the server device 160 may any type of device, and not necessarily a server. Also, as previously described, both the device 100 and server 160 may be Trusted Computing Bases (TCBs), the server 160 may have a hardware security module (HSM) and the device 100 may have a Trusted Execution Environment (TEE).

Also, in one embodiment, as will be described in more detail hereafter, an authentication device 180 may be utilized to process/authenticate/validate an identifier that is displayed on the secure display 139 of device 100 and may transmit the identifier through networks 150 over a different channel to server 160. Device 180 may be any type of device (e.g., as previously described). It should be appreciated that device 180 may be a device having at least a processor 182, a memory 184, an interface/communication subsystem 190, sensors 149, as well as other hardware and software components, to implement operations, some of which will be hereafter described. It should be appreciated sensors 149 of device 180 may be shared sensors with device 100 or may be independent and may not be shared sensors.

As has been previously described, although presently strong authentication techniques are provided for authentication of servers to devices, typically, commonly utilized devices have a relatively weak process to identify themselves and be authenticated by the server. In this way, there is a stronger probability of MiTM attacks on information sent from the device to the server.

In one embodiment, device 100 may initiate a process including a one-time initial provisioning process and then an on-demand device authentication process. As an example, in order to implement the one-time initial provisioning process with a server 160, device 100 under the control of processor 102 coupled to the interface 130 and operating in a secure mode 105 may be configured to: command the transmission of a nonce through the interface 130 to server 160 over a channel (e.g., a secure or non-secure channel) through networks 150 and may then receive a response through the interface 130 from server 160 including an identifier and the nonce over the channel of networks 150, in which, the response may be signed with a private key of the server. Device 100 under control of processor 102 operating in a secure mode 105 may then: verify the signature using a public key of the server; verify the nonce; and store the identifier in secure storage 137. In this way, device 100 now has a securely stored identifier for association with the server 160. It should be appreciated that the nonce may be any unique identifier. Examples of this may include a universal unique I.D. (UUID), an encrypted blob, etc. Similarly, it should be appreciated that the identifier provided by server 160 may be a unique identifier. Examples of this may include a universal unique I.D. (UUID), a random number (e.g., a 128 bit number), an encrypted blob, or any suitable unique type of identifier that has a high probability of uniqueness. Then, when device 100 wishes to authenticate itself to server 160, the identifier, or a derivative of the identifier (e.g., a QR code or time based code), may be displayed on secure display 139 to initiate authentication with server 160, as will be described. As will be described below, an authentication device 180 may be used to obtain the identifier and transmit the identifier to the server 160. In one embodiment, the identifier may be encrypted. Also, although a server is described as one example, it should be appreciated that the server device 160 may any type of device, and not necessarily a server.

In one embodiment, a user may initiate a special state in which the identifier is displayed on the secure display 139 of the display device 113 and the user can then transmit the displayed identifier to server 160 over a different trusted channel for authentication purposes (e.g., a different out-of-band channel) via device 100 itself or via an authentication device 180, different techniques of which, will be described hereafter. Aspects of the secure display 139 will be briefly described in more detail. The secure display environment may be controlled by the use of processor 102 operating in a secure mode 105 in order to prevent malicious software that may run alongside and concurrently to trusted applications from reading, writing, modifying, blocking, or tampering with the content of the screen displayed on the secure display 139 of the display device 113. For example, by utilizing the secure display environment, an attacker may be prevented from obtaining the identifier displayed on the secure display 139 of the display device 113. By utilizing the secure display environment, the identifier may be displayed on the secure display 139 of display device 113 without the risk of malicious software obtaining it (e.g., via a screenshot). The secure display 139 may share the same physical screen on the display device 113 with other applications running in secure and non-secure modes.

In one embodiment, authentication to server 160 may include transmitting the identifier displayed on the secure display 139 to server 160 over a different channel than the channel utilized for initial provisioning. It should be appreciated that the different channel may be any sort of suitable trusted channel through network(s) 150. Once authentication has been performed, device 100 may utilize the services, applications, functions, etc., provided by server 160 in a secure environment.

In one embodiment, the identifier displayed on secure display 139 of device 100 that is to be transmitted to server 160 over a different channel through networks 150 may be accomplished by utilizing authentication device 180. Authentication device 180 may obtain the identifier displayed on the secure display 139 and may then transmit the identifier (via communication interface 190) over a different channel through networks 150 to server 160 to authenticate device 100 to server 160. As one example, the identifier from the secure display 139 may be obtained by authentication device 180 by authentication device 180 taking a picture shot of the secure display 139 (e.g., via camera sensor 149) and may then transmit the identifier through a different channel through networks 150 to server 160 to authenticate device 100 to server 160. As another example, a user may utilize authentication device 180 to manually enter (e.g., through a keyboard, keypad, touch screen, etc.) the identifier from the secure display 139 and authentication device 180 may then transmit the identifier through a different channel through networks 150 to server 160 to authenticate device 100 to server 160. As yet another example, a user may utilize authentication device 180 as a phone to make a voice call (e.g., via microphone sensor 149) to server 160 through a different channel of networks 150 by reading the identifier from the secure display 139 to server 160 (via a human operator or a computer operator) to authenticate device 100 to server 160 (e.g., also in some embodiments, authentication device 180 itself may be considered to be the human operator or computer operator, as will be described). As yet even another example, the identifier displayed on the secure display 139 may be a bar code (e.g., a QR code) and the bar code may be obtained by a bar code scan performed by authentication device 180 (e.g., via camera sensor 149) which may then be transmitted through a different channel through networks 150 to server 160 to authenticate device 100 to server 160.

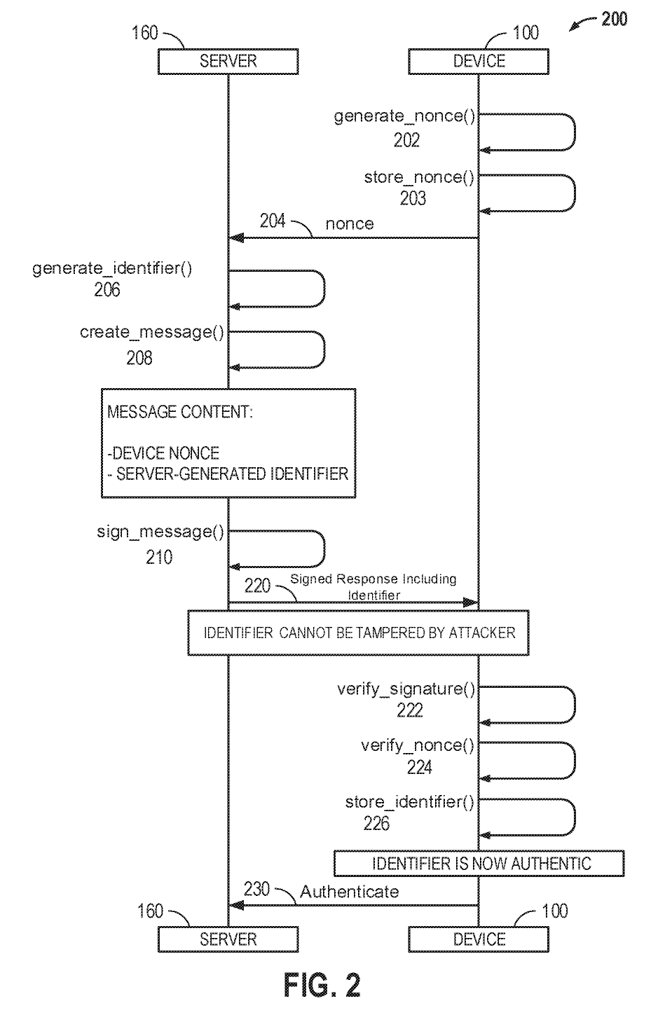

It should be appreciated that inputs to device 100 or authentication device 180 may occur with the use of a secure input from the user. Secure inputs may be controlled by the processor operating in a secure mode. For example, different types of user inputs (e.g., keypad, keyboard, touch-screen events, fingerprints, voice input, audio input, motion input, biometric input, buttons, external devices, etc.) may be directed to the secure processor and controlled by secure processor. Secure input prevents malicious software that may run alongside and concurrently to trusted applications from reading, writing, modifying, injecting, or denying user input. With secure input functionality, applications operating with the identifier displayed on the secure display according to embodiments described herein may share the same physical devices with other applications running in secure and non-secure modes. Utilizing the secure input functionality is not required for implementation of embodiments described herein, but adds an extra layer of protection. With additional reference to FIG. 2, a flow diagram of a process 200 will be described to illustrate the one-time initial provisioning process and thereafter to initiate authentication. At point 202, device 100 running in secure mode 105 may generate a nonce and at point 203 may store the nonce in secure storage 137. Device 100 may then transmit the nonce (line 204) to server 160 over a channel through the networks. At point 206, server 160 may generate an identifier and at point 208 may create a message or response that includes the device nonce and the server-generated identifier. Further, at point 210, server 160 may sign the message or response with a private key. At line 220, server 160 may transmit the signed response to device 100. It should be noted that the message, including the identifier and nonce, cannot be tampered with by an attacker due to the message being cryptographically signed with the server private key. At point 222, device 100 verifies the signature. At point 224, device 100 verifies the nonce. At point 226, device 100 stores the identifier into secure storage such that the identifier is now authentic. Based upon the stored server-provided authentic identifier, device 100, at line 230, may authenticate itself to server 160, to perform an application, service, function, etc., provided by server 160 after authentication. Examples of the authentication process based upon the display of the identifier on secure display 139 will be hereafter described.

With additional reference to FIG. 3, examples of authentication techniques will be hereafter described. As has been described, to initiate authentication, device 100 displays the identifier 226 on secure display 139 of display device 113 to initiate the authentication process with server 160. In particular, by utilizing a Trusted Execution Environment (TEE), in conjunction with secure display 139, in which processor 102 is operating in a secure mode 105, secure display 139 implements a secure environment to display identifier 226. In particular, as has been described, identifier 226 displayed on secure display 139 may be sent over a different channel or out-of-band channel than that utilized for the initial provisioning process through networks 150 to server 160. In particular, as has been described, a separate authentication device 180 may be utilized to obtain the identifier 226 displayed on the secured display 139 of device 100 and may then transmit the identifier 226 over a different channel through networks 150 to server 160. A few examples will be hereafter described, although, it should be appreciated that any type of authentication device and implementation methods may be utilized.

As one example, identifier 226 from the secure display 139 of device 100 may be obtained by authentication device 180 taking a picture shot 302 of the secure display 139 (e.g., via camera sensor 149) and may then transmit the identifier 226 through a different channel through networks 150 to server 160 to authenticate device 100 to server 160. Also, as has been previously described, in some embodiments, a derivate identifier may be used, in which, the derivative identifier may be one of or a combination of: a provided ID, a QR code, a current trusted time (e.g., a server-signed timestamp), etc. As another example, a user may utilize authentication device 180 to manually enter 304 (e.g., through a keyboard, keypad, touch screen, etc.) the identifier 226 from the secure display 139 and authentication device 180 may then transmit the identifier through a different channel through networks 150 to server 160 to authenticate device 100 to server 160. As yet another example, a user may utilize authentication device 180 as a phone to make a voice call 306 (e.g., via microphone sensor 149) to server 160 through a different channel of networks 150 by reading the identifier from the secure display 139 to server 160 (via a human operator or a computer operator) to authenticate device 100 to server 160. As yet even another example, the identifier 226 displayed on the secure display 139 may be a bar code (e.g., a QR code) and the bar code may obtained by a bar code scan 308 performed by authentication device 180 (e.g., via camera sensor 149) which may then be transmitted through a different channel through networks 150 to server 160 to authenticate device 100 to server 160.

It should be appreciated that these are merely examples of different types of functions that a separate authentication device 180 having a plurality of different types of sensors 149 or the device 100 itself may utilize to obtain the identifier 226 displayed on the secure display 139 of the display device 113 of device 100 such that the identifier 226 may be obtained and transmitted through a different out-of-band channel (that is trusted) (through network(s) 150) in order to authenticate device 100 to server 160. It should be appreciated that these are merely examples and that any suitable type of function performed by any type of authentication device 180 or device 100 itself to obtain an identifier 226 from the secure display 139 of a device 100, which can then be transmitted through a different channel to server 160 for authentication, may be utilized, and that these are merely examples. Also, in some embodiments, device 100 itself may in a secure fashion obtain identifier 226 from the secure display 139 and transmit the identifier over a separate different channel (e.g., a different channel than utilized to initially provision device 100) through networks 150 to server 160 to authenticate device 100 to server 160. Thus, in one embodiment, an authentication device 180 is not necessary and device 100 itself may perform all the previous operations described being performed by the authentication device to obtain an identifier (e.g., obtaining a picture shot, obtaining a manual entry, performing a voice call, obtaining a bar code, etc.) and may transmit the identifier itself via a different channel through the network 150 to the server 160. Also, it should be appreciated as other examples, authentication device 180 may be a human being with a pen and paper and the human being may transmit the identifier over a separate different channel through networks 150 to server 160 to authenticate device 100 to server 160. As another example, the authentication device may be a human being with a pen and paper and the human being may utilize device 100 or server 160 (e.g., the authentication device 180 being embedded in device 100 or server 160) to transmit the identifier.

After authentication of device 100 with server 160 is successful (e.g., the server 160 authenticates the device 100), device 100 may implement the services, applications, function, etc., provided by server 160. On the other hand, if authentication is not successful, then device 100 may be prohibited from utilizing server 160.

Utilizing the previously described embodiments, both the one-time initial provisioning and the on-demand device identification processes are not vulnerable to man-in-the-middle attacks. Further, mutual authentication is not required. Moreover, devices do not need to be identified by universally known identifiers, such as, a serial number. In particular, by utilizing the one-time initial provisioning and the on-demand device identification thereafter, a secure authentication process is provided that is immune to man-in-the-middle attacks and provides a simple process for a server to authenticate a device (based upon the identifier) without requiring ahead of time, device key provisioning.

It should be appreciated that although a server and a device are provided as examples, the one-time initial provisioning and thereafter on-demand device identification processes may be utilized between any types of devices. It should be appreciated that device 100, server 160, and authentication device 180 may be any type of device. Further, device 100, server 160, and authentication device 180 may include appropriate processors, memories, and communication interfaces to implement the previously described function.

It should be appreciated that aspects of the previously described processes may be implemented in conjunction with the execution of instructions by a processors of devices (e.g., device 100, server 160, authentication device 180), as previously described. Particularly, circuitry of the devices, including but not limited to processors, may operate under the control of a program, routine, or the execution of instructions to execute methods or processes in accordance with embodiments described (e.g., the processes and functions of FIGS. 1-3). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A device comprising:
a storage;
an interface; and
a processor coupled to the interface and operable in a secure mode, the processor configured to:
command the transmission of a nonce through the interface to a server over a channel;
receive through the interface a response from the server including an identifier and the nonce over the channel, wherein the response is signed with a private key of the server;
verify the signature using a public key of the server;
verify the nonce;
store the identifier in the storage; and
display the identifier on a secure display to initiate authentication with the server.

2. The device of claim 1, wherein authentication with the server, further comprises transmitting the identifier displayed on the secure display to the server over a different channel.

3. The device of claim 2, wherein transmitting the identifier displayed on the secure display to the server over the different channel, further comprises an authentication device obtaining the identifier displayed on the secure display and transmitting the identifier over the different channel.

4. The device of claim 2, wherein the identifier from the secure display is obtained by a picture shot.

5. The device of claim 2, wherein the identifier from the secure display is obtained by manual entry.

6. The device of claim 2, wherein the identifier from the secure display is obtained by providing a voice call.

7. The device of claim 2, wherein the identifier displayed on the secure display is a bar code and the bar code is obtained by a bar code scan.

8. A method comprising:
transmitting a nonce to a server over a channel;
receiving a response from the server including an identifier and the nonce over the channel, wherein the response is signed with a private key of the server;
verifying the signature using a public key of the server;
verifying the nonce;
storing the identifier in a storage; and
displaying the identifier on a secure display to initiate authentication with the server.

9. The method of claim 8, wherein authentication with the server, further comprises transmitting the identifier displayed on the secure display to the server over a different channel.

10. The method of claim 9, wherein transmitting the identifier displayed on the secure display to the server over the different channel, further comprises an authentication device obtaining the identifier displayed on the secure display and transmitting the identifier over the different channel.

11. The method of claim 9, wherein the identifier from the secure display is obtained by a picture shot.

12. The method of claim 9, wherein the identifier from the secure display is obtained by manual entry.

13. The method of claim 9, wherein the identifier from the secure display is obtained by providing a voice call.

14. The method of claim 9, wherein the identifier displayed on the secure display is a bar code and the bar code is obtained by a bar code scan.

15. A non-transitory computer-readable medium including code that, when executed by a processor operating in a secure mode of a device, causes the processor to:
transmit a nonce to a server over a channel;
receive a response from the server including an identifier and the nonce over the channel, wherein the response is signed with a private key of the server;
verify the signature using a public key of the server;
verify the nonce;
store the identifier in a storage; and
display the identifier on a secure display to initiate authentication with the server.

16. The computer-readable medium of claim 15, wherein authentication with the server, further comprises code to transmit the identifier displayed on the secure display to the server over a different channel.

17. The computer-readable medium of claim 16, wherein transmitting the identifier displayed on the secure display to the server over the different channel, further comprises an authentication device comprising code to obtain the identifier displayed on the secure display and transmit the identifier over the different channel.

18. The computer-readable medium of claim 16, wherein the identifier from the secure display is obtained by a picture shot.

19. The computer-readable medium of claim 16, wherein the identifier from the secure display is obtained by manual entry.

20. The computer-readable medium of claim 16, wherein the identifier from the secure display is obtained by providing a voice call.

21. The computer-readable medium of claim 16, wherein the identifier displayed on the secure display is a bar code and the bar code is obtained by a bar code scan.

22. A device comprising:
means for transmitting a nonce to a server over a channel;
means for receiving a response from the server including an identifier and the nonce over the channel, wherein the response is signed with a private key of the server;
means for verifying the signature using a public key of the server;
means for verifying the nonce;
means for storing the identifier in a storage; and
means for displaying the identifier on a secure display to initiate authentication with the server.

23. The device of claim 22, wherein authentication with the server, further comprises means for transmitting the identifier displayed on the secure display to the server over a different channel.

24. The device of claim 23, wherein the means for transmitting the identifier displayed on the secure display to the server over the different channel, further comprises an authentication device obtaining the identifier displayed on the secure display and transmitting the identifier over the different channel.

25. The device of claim 23, wherein the identifier from the secure display is obtained by a picture shot.

26. The device of claim 23, wherein the identifier from the secure display is obtained by manual entry.

27. The device of claim 23, wherein the identifier from the secure display is obtained by providing a voice call.

28. The device of claim 23, wherein the identifier displayed on the secure display is a bar code and the bar code is obtained by a bar code scan.
